(19) United States
(12) Patent Application Publication
(10) Pub. No.: US 2026/0175895 A1
(43) Pub. Date: Jun. 25, 2026

(54) MODULAR SKID ENCLOSURE FOR SKID MOUNTED PUMPS

(71) Applicant: Cornell Pump Company LLC, Clackamas, OR (US)

(72) Inventors: Seth Michael James, Colton, OR (US); Jeremy Scott Ghent, Lancaster, SC (US); Ituah Johnny Rodriguez, Milwaukie, OR (US); Daniel Byron Sharp, Edgemoor, SC (US)

(21) Appl. No.: 19/187,170

(22) Filed: Apr. 23, 2025

Related U.S. Application Data
(60) Provisional application No. 63/737,864, filed on Dec. 23, 2024.
(60) Provisional application No. 63/743,345, filed on Jan. 9, 2025.

(51) Int. Cl. B62B 13/18; B60J 5/04; B62D 21/20; B62D 25/06; B62D 27/02; B62D 27/06; B62D 63/06; H02J 7/35; H02S 20/30

(52) U.S. Cl. CPC B62B 13/18; B60J 5/0491; B62D 21/20; B62D 25/06; B62D 27/023; B62D 27/065; B62D 63/064; H02J 7/35; H02S 20/30

(57) ABSTRACT

An enclosure for a skid assembly is provided. The enclosure mounts to a modular trailer body that can be converted between a wheeled assembly and a drag skid. The enclosure is bolted to the trailer body to muffle sound produced by the pump and engine. The enclosure is a modular assembly provided as a “flat pack” that can be assembled with bolted connections, allowing the enclosure to be delivered efficiently and in a cost effective manner. The enclosure provides for improved access by including coach-style doors on both sides, using removeable top panels, and including a front side louver bracket on hinges.

### CROSS-REFERENCE TO RELATED APPLICATION

This application claims priority to under 35 U.S.C. § 119, based on U.S. Provisional Application Nos. 63/743,345, filed Jan. 9, 2025, titled “Modular Skid Enclosure for Skid Mounted Pumps,” as well as U.S. Provisional Ser. No. 63/737,864 filed Dec. 23, 2024, titled “Convertible Modular Skid with Check Valve Support for Pumps with Internal Combustion Engines,” the disclosures of which are hereby incorporated by reference.

### BACKGROUND OF THE INVENTION

Portable pump systems typically include a pump coupled to an engine and other components and mounted on a fabricated skid. A skid assembly includes the pump itself (such as a centrifugal pump) and a driver (such as a diesel engine) that is mounted to a steel base. Such skid assemblies are configured to permit movement of an entire pump system without requiring disassembly and re-assembly at a location of use. Enclosures may be provided to muffle sound produced by the pump and engine, as well as protect the enclosed components.

### BRIEF DESCRIPTION OF THE DRAWINGS

FIG. 1 is a left side perspective view of an exemplary embodiment of an enclosed modular skid assembly, according to an implementation described herein;

FIG. 2 is an assembly view for an enclosure mounted to a modular skid;

FIG. 3 is a perspective view of an exemplary embodiment of a frame of an enclosure;

FIGS. 4 and 5 are left side and right side perspective views, respectively, of an exemplary embodiment of an enclosed modular skid assembly, shown with open side doors;

FIG. 6 is a partial left side perspective view of the enclosed modular skid assembly showing a removeable rear panel, according to an implementation;

FIG. 7 is a left side perspective view of the enclosed modular skid assembly showing removable roof panels;

FIG. 8 is a partial front perspective view of an embodiment of the enclosed modular skid assembly;

FIGS. 9 and 10 are a front and a right side perspective view, respectively, of an embodiment of the enclosed modular skid assembly, shown with an open front louver panel;

FIG. 11 is a perspective view illustrating an exemplary packing arrangement for a frame of an enclosure;

FIG. 12 is a perspective view illustrating an exemplary packing arrangement for roof panels, a front door, and a rear panel of an enclosure;

FIG. 13 is a perspective view illustrating an exemplary packing arrangement for side doors and side panels of an enclosure; and

FIG. 14 is a flow diagram of an exemplary process for assembling an enclosure for a skid assembly, according to an implementation.

### DETAILED DESCRIPTION

The following detailed description refers to the accompanying drawings. The same reference numbers in different drawings may identify the same or similar elements. Also, the following detailed description does not limit the invention.

Pumps and drivers of different sizes may be combined to meet customer specifications and/or field requirements. A skid assembly is generally configured to axially align an output shaft of a given driver (e.g., an internal combustion engine) with an input shaft of a given pump when the engine and pump are mounted on a frame or base. The frame is shaped to account for the dimensions of each motor-pump combination and provide the required alignment of shafts when the engine and pump are mounted on the frame.

For various reasons, including noise suppression and protection from industrial environments, it may be desirable to provide an enclosure for a skid assembly. The enclosure, however, creates access restrictions for performing maintenance and/or repairs to the pump, the engine, or different accessories. Furthermore, it may be desirable to add an enclosure as a retrofit for an open skid assembly.

Implementations described herein provide an enclosed modular skid assembly for a diesel engine (or another type of engine) and pump. The enclosed assembly mounts to a modular trailer body that can be converted between a wheeled assembly and a drag skid. The enclosure, which may be bolted on to the trailer body as an addition, may muffle sound produced by the pump and engine. To add the enclosure to an open skid assembly, a lifting bail from the open diesel trailer design is replaced with the enclosure. The enclosure itself may be provided as a “flat pack” that can be assembled with bolted connections, allowing the enclosure to be delivered efficiently and in a cost effective manner.

Individual panels on the enclosure can be replaced to accommodate different pump and engine types and sizes. For example, different configurations of a front louver panel and a rear panel may be provided for different pump and engine combinations. Additionally, pump suction and discharge flanges are both rear facing for ease of piping connections.

According to implementations described herein, the enclosure provides for improved access by including wide style “suicide” (or coach-style) doors on both sides, using removeable top panels, and providing a front (or trailer tongue) side louver bracket on hinges.

According to an implementation, an enclosure for a skid assembly includes a frame configured to be mounted on the skid assembly using bolted connections. The frame may include stanchions mounted at corners of the skid assembly. The stanchions may include a front-right vertical stanchion, a front-left vertical stanchion, a rear-right vertical stanchion, and a rear-left vertical stanchion, with the particular orientations used for descriptive purposes only. The enclosure further includes a right-side door set having two first door panels mounted to a first side of the frame via hinges and a left-side door set having two second door panels mounted to a second side of the frame via hinges. The enclosure may also include a front louver panel, mounted to a third side of the frame via hinges and removeable fasteners, and a rear panel, removably mounted to a fourth side of the frame via removable fasteners. The right side door set may be configured to open side-to-side to fully expose a horizontal distance between the front-right vertical stanchion and the rear-right vertical stanchion, and the left side door set may be configured to open side-to-side to fully expose a horizontal distance between the front-left vertical stanchion and the rear-left vertical stanchion. For example, neither of the right side door set nor the left side door set may include a center bar or pillar between the respective front stanchion and rear stanchion.

In another implementation, the frame may further include a right side rail joined by bolted connections to the front-right vertical stanchion and the rear-right vertical stanchion; a left side rail joined by bolted connections to the front-left vertical stanchion and the rear-left vertical stanchion, and a center crosspiece bolted to the left side rail and the right side rail. The center crosspiece may include a lifting eye, and the lifting eye may be recessed in the center crosspiece so as to not extend above the height of the frame.

The enclosure may also include multiple roof panels. One roof panel (e.g., a first or rear roof panel) may be configured to be mounted to the right side rail, the left side rail, and the center crosspiece via removable fasteners, and the other roof panel (e.g., a second or front roof panel) may also be configured to be mounted to the right side rail, the left side rail, and the center crosspiece via removable fasteners. Each roof panel may include a removable access panel. At least one of the access panels may have a solar panel mounted on the access panel. The access panel with the solar panel may be removed for ease of service/replacement. The solar panel may be configured to charge a battery for the skid assembly. According to another implementation, the rear roof panel may be completely removed (e.g., by removing screws/bolts) from the enclosure frame to permit removal of a pump from the enclosure (e.g., without having to remove the enclosure frame).

According to another implementation, the stanchions, right-side door set, left-side door set, front louver panel, rear panel, right side rail, left side rail, center crosspiece, and roof panels may be configured to be packaged as modular components and assembled with removable fasteners. The modular parts may reduce transit logistics/costs, reduce inventory and storage space requirements, simplify redesigns, and provide parts order replacement cost savings for customers.

According to still another implementation, the skid assembly includes a welded base with a pair of side rails, each of the side rails including a vertical portion and a horizontal top portion, the top portion having longitudinal slots formed therein. The enclosure/frame may be configured to rest on the side rails, such that additional support may not be required to hold the frame in place during assembly. The stanchions may be mounted to the welded base through the longitudinal slots. In one implementation, an additional backing plate may be used under the horizontal top portion to reduce stress at the bolted connection points.

The rear panel may be fully removeable and configured to match different pump configurations. Multiple different panels, with dimensions to fit at the back of the frame, may be formed to fit different inlet/outlet configurations. The rear panel may be selected, for example, from a group of multiple different rear panels to accommodate an installed pump on the skid assembly. The rear panel accommodates both inlet and outlet ports for the pump in the same panel, thus, freeing space on the other sides (e.g., left and right side) of the enclosure to provide unobstructed access to the pump and/or engine when the right side door set and/or left side door set are opened.

In another aspect, the skid assembly is convertible between a wheeled trailer configuration and a drag skid configuration. The enclosure may be configured to mount to the welded base when the skid assembly is in either of the wheeled trailer configuration or the drag skid configuration, without further modification to the enclosure.

In some implementations, an open skid assembly configuration may be converted to an enclosed design with minimal modification. From the open configuration, the check valve support may be changed, a discharge elbow added to fit the enclosed design, the lifting bail of the open configuration removed, and the engine air filter configuration modified. The enclosure may then be assembled over the pump skid package.

In still another aspect, the front louver panel, when secured to the frame, is configured to seal against a radiator of an engine mounted on the skid assembly. For example, the front louver panel may include a gasket material that abuts the perimeter facing of the radiator when the front louver panel is closed and secured to the frame. In another implementation, the louver panel may be incorporated as a hinged door to enable access to the radiator of the driving engine in the skid assembly.

In one implementation, a combination check valve and suction flange support plate may be provided. The combination support plate may be positioned, for example, under the check valve near the input port of the rear panel. The combination support plate may be bolted and slotted in a way that allows for flexibility of the flange location without the need for shimming. In some implementations, the combination support plate may be provided in different sizes to accommodate different pumps, flange sizes, and/or configurations.

In another implementation, a method of assembling an enclosure for a skid assembly is provided. The method includes selecting an enclosure kit sized for the skid assembly; assembling, via bolted connections, a frame for the enclosure; and resting the frame on a pair of longitudinal side rails of a skid base. The method may also include attaching each of multiple vertical stanchions of the frame to the skid base via removeable fasteners; attaching the right-side door set to a first side of the frame via hinges; and attaching the left-side door set to a second side of the frame via hinges. Each of the right side door set and the left side door set may open side-to-side to fully expose a horizontal distance between vertical stanchions of the frame. The method may additionally include attaching a front louver panel to a rear side of the frame via hinges and removeable fasteners; attaching a rear panel to a fourth side of the frame via removable fasteners; and attaching a first roof panel to via removable fasteners; and attaching the second roof panel via removable fasteners.

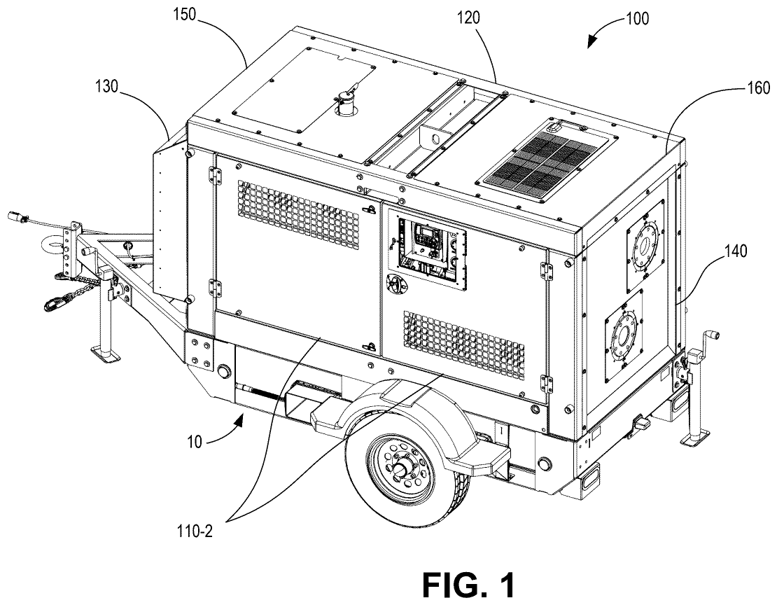

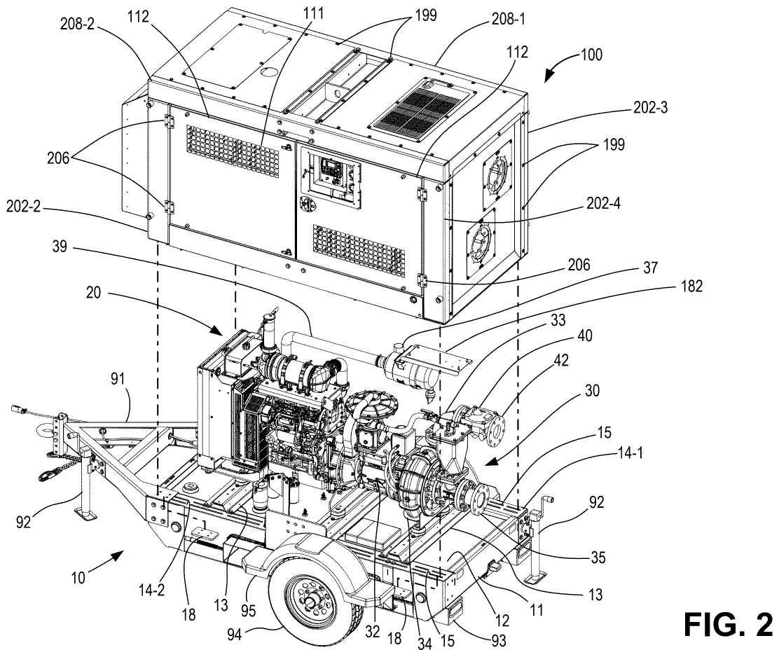

Referring to FIGS. 1 and 2, a skid assembly 10 with an enclosure 100 is illustrated. Skid assembly 10 may be configured to mount an engine 20 (e.g., a driver) with a pump 30 on a welded frame or base 11, such that the engine is aligned with the pump. The base 11 may be shaped to account for the dimensions of an engine-pump combination and provide the required axial alignment of shafts when engine 20 and pump 30 are mounted on the frame. In one implementation, a single base 11 size can be used for a range of different engine 20 and pump 30 sizes or configurations. In one implementation, skid assembly 10 may include features described in connection with U.S. Provisional Patent Application 63/737,864, filed Dec. 23, 2024, and incorporated by reference herein.

Skid assembly 10 may include welded base 11, a fuel tank 12, and mounting crosspieces 13. Engine 20 may be mounted on base 11 via one or more mounting crosspieces 13 selected to position engine 20 in alignment with corresponding pump 30. Pump 30 may include, for example, a centrifugal pump with, among other components, a bearing frame 32 and a volute 34. Each mounting crosspiece 13 may be removably secured to portions of welded base 11 such that the mounting locations of engine 20 and pump 30 may be adjusted longitudinally (front-to-back) allow for adjustment of the center of gravity or general alignment. In particular, slots in welded base 11 allow mounting crosspieces 13 to be moved forward or backward relative to base 11.

In one implementation, skid assembly 10 can be converted from a drag skid to a wheeled trailer and vice versa. A trailer conversion kit may include additional components configured to be bolted to welded base 11 to convert the drag skid package to a trailer package. The trailer conversion kit may include, for example, a trailer tongue 91 that projects from welded base 11, one or more jack mounts 92, one or more light boxes 93, a wheel/axle assembly 94, and fenders 95.

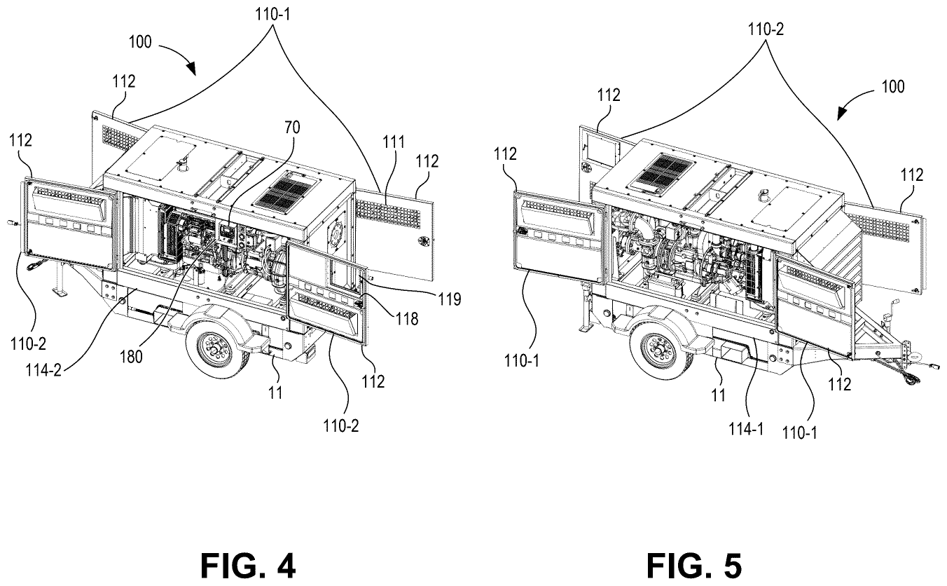

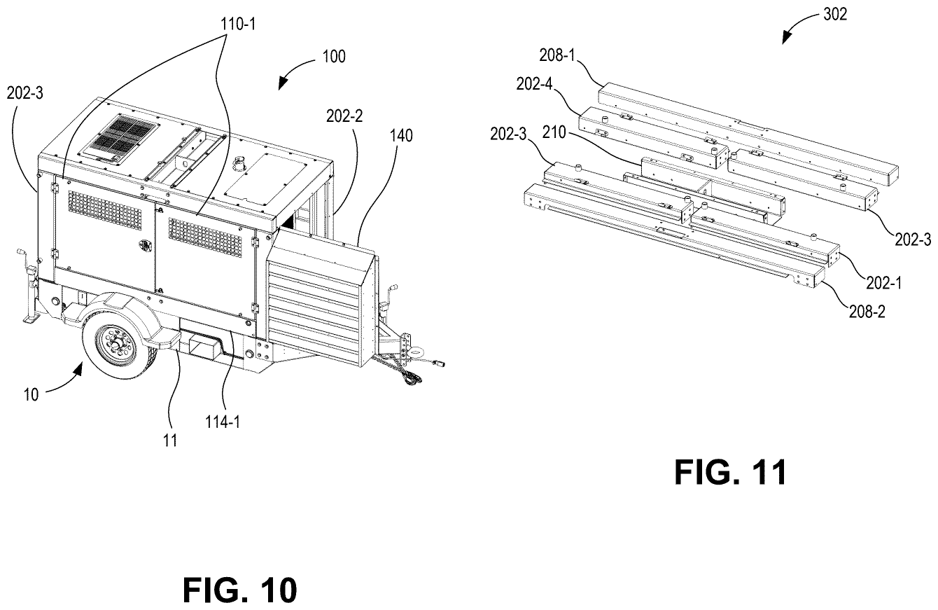

Enclosure 100 includes right-side door set 110-1 (shown in FIGS. 4, 5, and 10) and a left-side door set 110-2 (referred to herein collectively as door sets 110 or individually as door set 110) mounted on a frame 120. As described further herein, enclosure 100 may also include a front louver panel 130, a rear panel 140, a front roof panel 150, and a rear roof panel 160 mounted on frame 120.

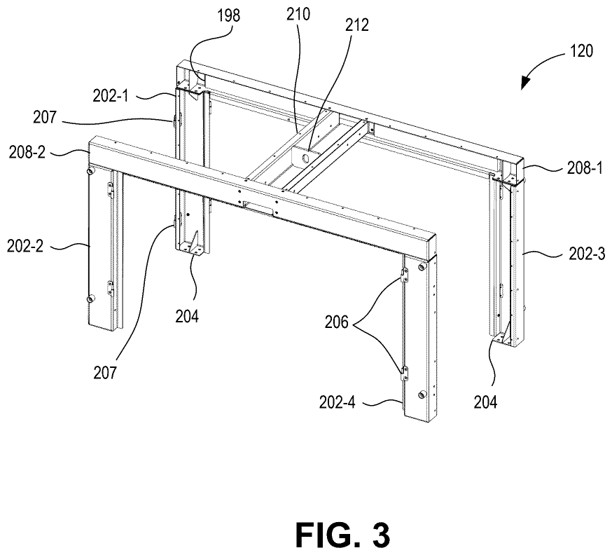

Frame 120 may be configured to be mounted on skid assembly 10 using bolted connections. As shown in FIG. 3, frame 120 includes stanchions 202-1 through 202-4 (referred to herein collectively as stanchions 202 and individually as stanchion 202), which may be mounted at corners of skid assembly 10. The stanchions 202 may include a front-right vertical stanchion 202-1, a front-left vertical stanchion 202-2, a rear-right vertical stanchion 202-3, and a rear-left vertical stanchion 202-4, with the particular orientations used for descriptive purposes only. Each stanchion 202 may have a substantially C-shaped cross section with end panels 204 capping each end to facilitate attachment to other components.

Enclosure 100 may be configured to mount to the welded base 11 when the skid assembly is in either of the wheeled trailer configuration or the drag skid configuration, without further modification to the enclosure. In the wheeled trailer configuration, stanchions 202-1 and 202-2 may set on top of a portion of trailer tongue 91 that overlaps welded base 11, as shown in FIG. 2. In the drag skid configuration, stanchions 202-1 and 202-2 may set directly on top of side rails 14, as described further herein.

Frame 120 may further include a right side rail 208-1 and a left side rail 208-2 (referred to herein collectively as side rails 208 and individually as side rail 208) joined by bolted connections corresponding front stanchions 202-1/202-2 and rear stanchions 202-3/202-4. As shown in FIG. 3, for example, a center crosspiece 210 may span between side rails 208. In one implementation, center crosspiece 210 may be positioned in the middle of the span between front stanchions 202-1/202-2 and rear stanchions 202-3/202-4. Center crosspiece 210 may include a lifting eye 212. In one implementation, center crosspiece 210 may be configured so that lifting eye 212 is recessed within center crosspiece 210 so as to not extend above the overall height of frame 120.

Stanchions 202, side rails 208, and center crosspiece 210 may be manufactured from a metal material, such as powder-coated steel, stainless steel, galvanized steel, aluminum, and/or another type of metal. In other implementations, stanchions 202, side rails 208, and center crosspiece 210 may be made from a composite material. Each of stanchions 202, side rails 208, and center crosspiece 210 may also include multiple holes (e.g., threaded holes, straight holes, etc.) configured to receive removeable fasteners 199 (e.g., bolts, screws, etc.) used to secure frame 120 to welded base 11 and to secure sound-insulated doors and/or panels (e.g., front louver panel 130, rear panel 140, front roof panel 150, rear roof panel 160, etc.) to the various faces of frame 120, as described further herein.

Door sets 110 may be mounted on a right side and a left side of frame 120. As shown in FIGS. 2-5, for example, each door set 110 may have two door panels 112 mounted to a stanchion 202 via hinges 206. Side base panels 114-1 and 114-2 (referred to collectively as side base panels 114 and individually as side base panel 114) may span between a corresponding front stanchion 202-1/202-2 and rear stanchion 202-3/202-4. Each of side base panels 114 and side rails 208 may include a doorstop flange that extends into the swing path of doors 112 to prevent doors 112 from swinging into the enclosed area of enclosure 100. As shown in FIGS. 4 and 5, each of door sets 110 may be configured with doors panels 112 opening side-to-side to fully expose a horizontal distance between corresponding front stanchions 202-1/202-2 and rear stanchions 202-3/202-4. Thus, in one implementation, right side door set 110-1 and left side door set 110-2 do not include a center bar or vertical pillar between the respective front stanchions 202-1/202-2 and rear stanchions 202-3/202-4.

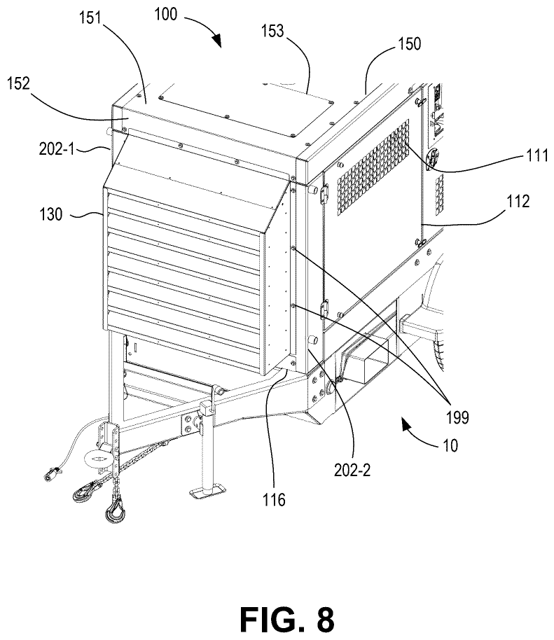

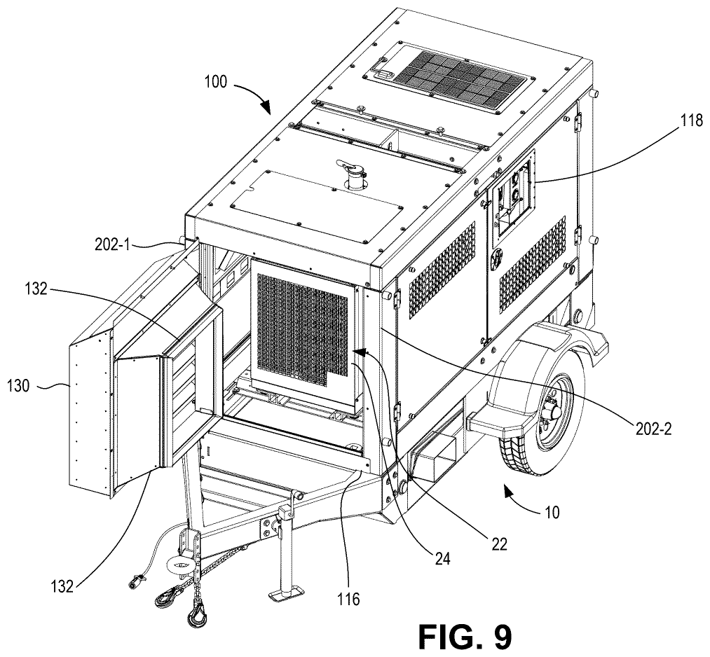

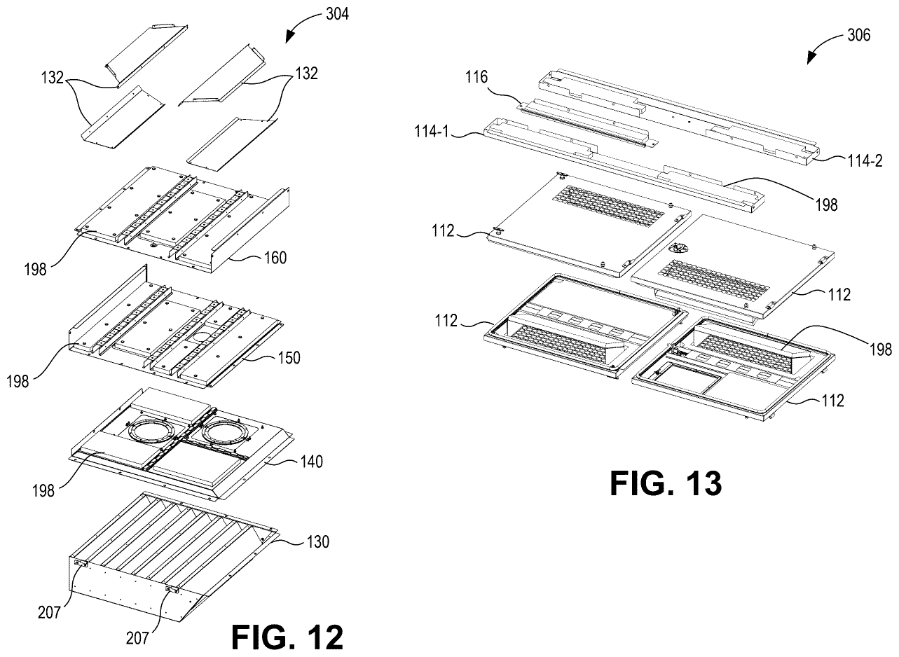

Enclosure 100 may include front louver panel 130 mounted to stanchion 202-1 and/or stanchion 202-2. Generally, air may be sucked into enclosure 100 via air intakes 111 in door panels 112, through an engine 20 fan (not shown), pushed past a radiator 22, and out through front louver panel 130. Louvers may be integrated into louver panel 130 and swing away to provide access to radiator 22. For example, as shown in FIG. 8, front louver panel 130 may be secured to the front face of frame 120 via hinges (hinges 207, FIG. 12) on a surface adjacent to stanchion 202-1 and removeable fasteners 199 along other edges of front louver panel 130. Front louver panel 130 may include louvered openings or other types of openings to receive outdoor air into enclosure 100. According to one implementation shown in FIG. 9, front louver panel 130 may be configured to swing on hinges 207 (FIG. 12) to open and fully expose a horizontal distance between front stanchions 202-1 and 202-2. For example, louver panel 130 may be incorporated as a hinged door to enable access to radiator 22 of engine 20 in skid assembly 10. A front base panel 116 may span between front stanchions 202-1 and 202-2. Front base panel 116 may include a doorstop flange that extends into the swing path of front louver panel 130 to provide a stopping point for closing front louver panel 130. In another implementation, front louver panel 130, when secured to frame 120, may be configured to seal against radiator 22 of engine 20. For example, front louver panel 130 may include a gasket assembly 132 that abuts the perimeter face 24 of radiator 22 when front louver panel 130 is closed and secured to frame 120. Thus, front louver panel 130 may be opened to provide easy access to radiator 22.

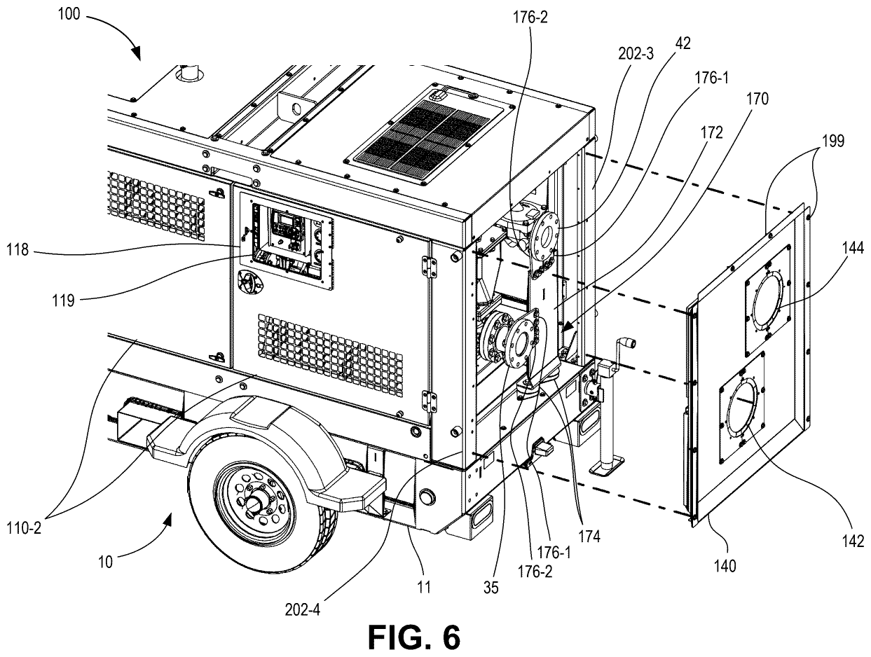

Enclosure 100 may also include rear panel 140, removably mounted to a rear side of frame 120. For example, as shown in FIG. 6, rear panel 140 may be secured via removable fasteners 199 to rear stanchions 202-3 and 202-4. In one implementation, rear panel 140 may be fully removeable (e.g., without hinges) and configured to match different pump 30 configurations. Multiple different rear panel 140 configurations, with dimensions to fit at the back of frame 120, may be formed to fit different arrangements/sizes of inlet and outlet piping for pump 30. Rear panel 140 may be selected, for example, from a group of multiple different rear panels to accommodate an installed pump on the skid assembly. According to an implementation, rear panel 140 may provide both a suction flange access port 142 and a discharge flange access port 144 in the same panel, thus freeing space on the other sides of the enclosure 100 (e.g., at right side door sets 110-1 and left side door set 110-2) to provide unobstructed access to pump 30 and/or engine 20 when the right side door set 110-1 and/or left side door set 110-2 are opened. Suction flange access port 142 and discharge flange access port 144 may provide openings for external piping to connect to, for example, a suction flange 35 of pump 30 and a discharge flange or check valve flange 42 of pump 30. Thus, rear panel 140 may be selected from a group of different rear panels, to accommodate the arrangement of suction flange 35 and discharge flange 42 on skid assembly 10. The arrangement of the suction flange access port 142 and discharge flange access port 144 through a single rear-facing panel (e.g. rear panel 140) provides for easier access to piping connections during setup and or disassembly of skid assembly 10/enclosure 100.

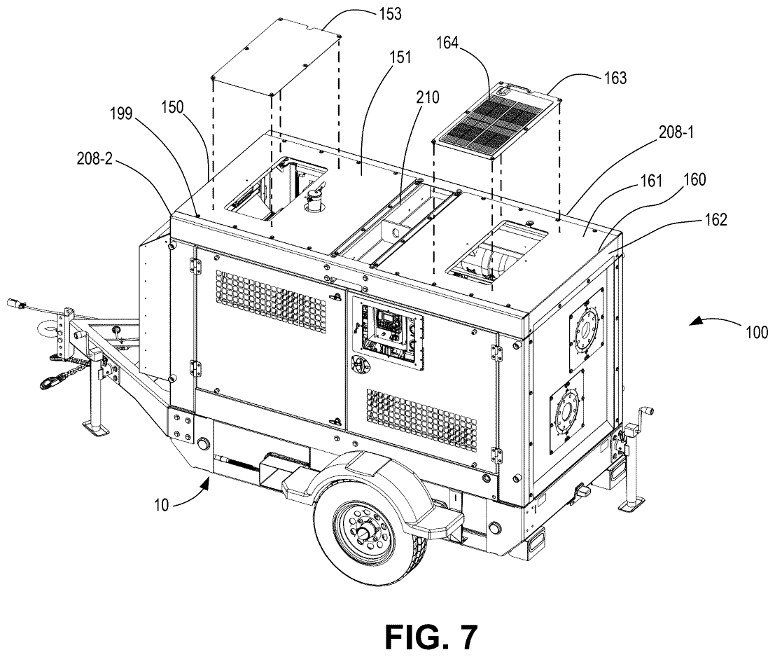

Enclosure 100 may also include multiple roof panels, such as front roof panel 150 and rear roof panel 160. As shown, for example, in FIG. 7, front roof panel 150 may be configured to be mounted to right side rail 208-1, left side rail 208-2, and a front side of center crosspiece 210 via removable fasteners 199. Rear roof panel 160 may be configured to be mounted to the right side rail 208-1, left side rail 208-2, and a rear side of center crosspiece 210 via removable fasteners 199. Front roof panel 150 may include a top pane 151 and a front side pane 152 (FIG. 8). Thus, when front roof panel 150 is installed on frame 120, a bend at the intersection of top pane 151 and a front side pane 152 provides additional stabilization for frame 120. Similarly, rear roof panel 160 may include a top pane 161 and a rear side pane 162. According to an implementation, rear roof panel 160 may be completely removed (e.g., by removing fasteners 199) from frame 120. When rear roof panel 160 is removed along with rear panel 140, full top and rear access to the interior space of enclosure 100 may be provided, such as to permit removal of pump 30 from enclosure 100 (e.g., without having to remove the frame 120 from welded base 11). For example, no support piece or cross-piece for frame 120 is included between stanchions 202-3 and 202-4 or along the rear halves of 208-1 and 208-2.

Front roof panel 150 may include a removable access panel 153, which may be removed to permit access to the interior of enclosure 100 (e.g., in the vicinity of radiator 22), such as for access to an engine coolant reservoir and/or radiator cap. Rear roof panel 160 may include a removable access panel 163, which may also be removed to permit access to the interior of enclosure 100 (e.g., in the vicinity of pump 30). At least one of access panels 153/163 may have a solar panel mounted on the access panel. For example, access panel 163 may have a solar panel 164 installed. Solar panel 164 may include a set of solar cells or panels to capture sunlight and charge a battery (not shown) and/or provide power to a monitoring device (not shown) for pump 30 when the power supplied by the battery is insufficient to meet the power demand of the pump monitoring device. In one implementation, access panel 163 may provide a flat smooth surface to receive an adhesive solar panel 164. Mounting of solar panel 164 to a dedicated access panel 163 allows for improved ease of installation and serviceability of solar panel 164.

Enclosure assembly 100 may be assembled with a skid assembly 10 as original equipment or provided as a retrofit unit for skid assembly 10. Each of side rails 208, door panels 112, side base panels 114, front base panel 116, rear panel 140, front roof panel 150, rear roof panel 160, among others, may include sound-absorbing insulation on various inside-facing surfaces to muffle sound produced during operation of engine 20 and pump 30.

According to another implementation, during assembly, frame 120 and/or enclosure 100 may be configured to sit or rest on skid assembly 10 prior to frame 120 be fastened to welded base 11. The weight of frame 120 is configured to be supported on welded base 11 during the attachment process. As shown in FIG. 2, welded base 11 of skid assembly 10 may include a pair of side rails 14-1 and 14-2 (referred to herein collectively as side rails 14 and individually as side rail 14), each of the side rails 14 may include a vertical portion and a horizontal top portion having longitudinal slots 15 formed therein. Frame 120 may be configured to rest on the side rails 14, such that additional support may not be required to hold the frame in place during assembly. Each of stanchions 202 may be mounted to one of side rails 14 using bolted connections through the longitudinal slots 15. In one implementation, an additional backing plate 18 may be used under the horizontal top portion of side rail 14 where each stanchion mates to reduce stresses at the bolted connection points. According to another implementation, mounting crosspieces 13 and enclosure 100 may be mounted to the same surface of welded frame 11. That is, side rails 14 and longitudinal slots 15 may be configured to permit mounting crosspieces 13 on the horizontal top portion of each side rail 14 without interference to side base panels 114, front base panel 116, and stanchions 202 on the same horizontal top pane. Mounting of both mounting crosspieces 13 and stanchions 202 on the same horizontal top portions of side rails 14 may simplify assembly and alignment of enclosure 100 onto skid assembly 10.

As shown in FIGS. 4 and 6, for example, according to an implementation, a control panel mount 180 may be configured to be bolted to frame 120 and position a control panel 70 relative to align with an access panel 118 in one of doors 112 and other components of skid assembly 10. In one implementation, control panel mount 180 may be configured to attach to side rail 208-2 and provide a vertical surface for mounting a control panel 70 within enclosure 100. Control panel mount 180 may be provided in different sizes to accommodate different sized control panels 70 and/or other monitoring devices. Access panel 118 may include, for example, a hinged door with a clear (e.g., glass, plastic, etc.) section 119 to view control panel 70. Control panel mount 180 may partly enclose a control panel 70 with an opening exposed to access panel 118. Access panel 118 may be configured to be opened and closed to allow physical access to control panel 70 when door 112 is closed.

In some implementations, enclosure 100 may be added to an open skid assembly 10 with minimal modification to the skid assembly 10. In changing from an open configuration to an enclosed configuration, for example, a discharge elbow 33 (FIG. 2) may be added to fit the enclosed design, a combination check valve and suction flange support 170 (FIG. 6) may be provided, an engine air filter 37 (FIG. 2) configuration may be modified, and a lifting bail of the open configuration may be removed. Enclosure 100 may then be assembled onto the pump skid package 10.

As shown in FIG. 2, discharge elbow 33 may be attached to an output flange of pump 30 and orient a check valve 40 toward rear panel 140. Check valve 40 may be attached at the output flange of pump volute 34 to prevent backflow into pump 30. To support the cantilever arrangement from discharge elbow 33, in one implementation, combination check valve and suction flange support 170 may be provided, such as shown in FIG. 6.

Combination check valve and suction flange support 170 may be configured for use with enclosure 100. As shown in FIG. 6, support 170 may be positioned, for example, under the check valve 40 next to suction port flange 35. The support 170 may be bolted and slotted in a way that allows for flexibility of the check valve flange 42 location without the need for shimming (e.g., to align flanges). In some implementations, support 170 may be provided in different sizes to accommodate different pumps, flange sizes, and/or configurations.

Combination check valve and suction flange support 170 may generally be configured to support (or brace) a check valve 40 that is attached to a discharge elbow 33 of volute 34. According to an implementation, support 170 may include a plate 172 configured to extend vertically from a pair of shock mounts 174 that are installed to welded frame 11 or a mounting crosspiece 13. A pair of braces 176-1/176-2 may be bolted or otherwise connected to plate 172 and partially surround a portion of check valve 40 on opposite sides. In one implementation, braces 176-1 and 176-2 may include an arc-shaped portion that substantially matches the outside diameter of the check valve 40 piping and a bolt hole pattern that aligns with the bolt holes of the check valve flange 42. Thus, braces 176-1 and 176-2 together may at least partially surround check valve 40 piping over more than 180 degrees of the pipe circumference. In one implementation, an additional pair of braces 176-1/176-2 may be attached to support 170 to reinforce suction piping behind suction port flange 35 in a similar manner to that of check valve 40, as shown in FIG. 6.

As a further modification to accommodate enclosure 100, a bent pipe section 39 (FIG. 2) may be used to position engine air filter 37 under rear roof panel 160. A bracket assembly 182 may secure air filter 37 to roof panel 160, for example. In one implementation, air filter 37 may be configured such that an axis of the cylindrical air filter 37 is parallel to top pane 161 of roof panel 160.

According to another implementation, enclosure 100 may be stored and shipped as modular components that may be assembled, for example, as a field installation with bolted connections. As shown in FIG. 11, components of frame 120, including stanchions 202, side rails 208, and center crosspiece 210 may be flat packed as a modular package 302. As shown in FIG. 12, front louver panel 130 with gasket assembly 132, rear panel 140, front roof panel 150, and rear roof panel 160 may be flat packed as a modular package 304. As shown in FIG. 13, door panels 112, side base panels 114, and front base panel 116 may be flat packed as a modular package 306. As shown, for example, in FIGS. 12-13, each of side rails 208, door panels 112, side base panels 114, front base panel 116, rear panel 140, front roof panel 150, rear roof panel 160, among others, may include sound-absorbing insulation 198 on various inside-facing surfaces to muffle sound produced during operation of engine 20 and pump 30.

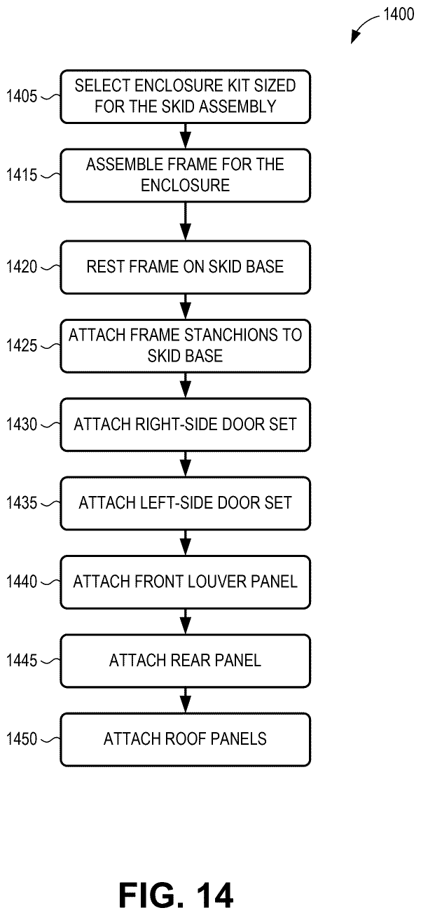

FIG. 14 is a flow chart of an example process 1400 for assembling enclosure 100 on a skid assembly 10. Process 1400 may be performed, for example, by a supplier of diesel skid assemblies, a pump manufacturer, or some other entity associated with providing pumps and engines to work sites.

Referring to FIG. 14, process 1400 may include selecting an enclosure kit sized for a skid assembly (block 1405). For example, a technician may select an enclosure kit for enclosure 100 that matches, for example, the length and width dimensions of welded base 11. The enclosure kit may include, for example, modular packages 302, 304, and 306, along with removeable fasteners 199 and/or other associated removable fastening hardware (e.g., bolts, washers, nuts, screws, etc.). Some components of modular packages 302, 304, or 306 may be sized for specific engine and/or pump types. For example, rear panel 140 may be specifically configured for a particular pump size/type.

Process 1400 may also include assembling, via bolted connections, a frame for the enclosure (block 1415). For example, vertical stanchions 202, side rails 208, and center crosspiece 210 may be bolted together to form frame 120.

Process 1400 may include resting the frame on a pair of longitudinal side rails of a skid base (block 1420), attaching the vertical stanchions to the skid base (block 1425); attaching the right-side door set to a first side of the frame via first hinges (block 1430); and attaching the left-side door set to a second side of the frame via second hinges (block 1435). For example, frame 120 may be placed on welded base 11 with each of stanchions 202-1 through 202-4 resting on a portion of one of side rails 14. Stanchions 202 may be secured to side rails 14 via inserting bolts through selected slots 15. With frame 120 in place, door sets 210-1 and 210-2 may be hung on hinges 206 such that each door set 110 opens side-to-side to fully expose the distance between front stanchions 202-1/202-2 and rear stanchions 202-3/202-4.

Process 1400 may additionally include attaching a front louver panel to a front side of the frame via third hinges and removeable fasteners (block 1440) and attaching the rear panel to a back side of the frame via removable fasteners (block 1445). For example, front louver panel 130 may be secured to the front face of frame 120 via hinges 207 on a surface adjacent to stanchion 202-1 and removeable fasteners 199 along other edges of front louver panel 130. Also, rear panel 140 may be secured via removable fasteners 199 to rear stanchions 202-3 and 202-4.

Process 1400 may further include attaching a front roof panel and a rear roof panel to the frame (block 1450). For example, front roof panel 150 may be secured to the right side rail 208-1, left side rail 208-2, and a front side of center crosspiece 210 via removeable fasteners 199. Rear roof panel 160 may be secured to the right side rail 208-1, left side rail 208-2, and a rear side of the center crosspiece 210 via removable fasteners 199.

As used herein, the terms removeable fasteners (such as removeable fasteners 199) and bolted connections may include threaded bolts (e.g., lag bolts), bolts and corresponding nuts, bolt/washer/nut combinations, screws, or other threaded fasteners, that may be used to secure components when holes in different mated surfaces of enclosure 100 and/or skid assembly 10 are aligned. In other implementations, removeable fasteners may encompass another type of removable fastener (e.g., a cotter-pin, clip, rivet, etc.) that can secure components of the skid assembly or corresponding enclosure. In some implementations, fasteners may be provided in different sizes for different applications on the enclosed skid assembly.

While a series of blocks has been shown with regard to the processes illustrated in FIG. 14, the order of the blocks may be modified according to other embodiments. Further, non-dependent blocks may be performed in parallel. Additionally, other processes described in this description may be modified and/or non-dependent operations may be performed in parallel.

As set forth in this description and illustrated by the drawings, reference is made to “an exemplary embodiment,” “an embodiment,” “embodiments,” etc., which may include a particular feature, structure, or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the terms “implementation,” “implementations,” “aspect,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such.

What is claimed is:

1. An enclosure for a skid assembly, comprising:
a frame configured to be mounted on the skid assembly using removeable fasteners, wherein the frame includes stanchions mounted at corners of the skid assembly, the stanchions including a front-right vertical stanchion, a front-left vertical stanchion, a rear-right vertical stanchion, and a rear-left vertical stanchion;
a right-side door set including two first door panels mounted to a first side of the frame via first hinges;
a left-side door set including two second door panels mounted to a second side of the frame via second hinges;
a front louver panel mounted to a third side of the frame via third hinges and removeable fasteners; and
a rear panel removably mounted to a fourth side of the frame via removable fasteners,
wherein the right side door set opens side-to-side to fully expose a first horizontal distance between the front-right vertical stanchion and the rear-right vertical stanchion, and
wherein the left side door set opens side-to-side to fully expose a second horizontal distance between the front-left vertical stanchion and the rear-left vertical stanchion.

2. The enclosure of claim 1, wherein the frame further includes:
a right side rail joined to the front-right vertical stanchion and the rear-right vertical stanchion by bolted connections,
a left side rail joined to the front-left vertical stanchion and the rear-left vertical stanchion by bolted connections, and
a center crosspiece bolted to the left side rail and the right side rail.

3. The enclosure of claim 2, wherein the center crosspiece includes a lifting eye, and wherein the lifting eye is recessed in the center crosspiece and does not extend above a height of the frame.

4. The enclosure of claim 2, further comprising:
a first roof panel configured to be mounted to the right side rail, the left side rail, and the center crosspiece via removable fasteners, and
a second roof panel configured to be mounted to the right side rail, the left side rail, and the center crosspiece via removable fasteners.

5. The enclosure of claim 4, wherein the first roof panel includes a removable access panel.

6. The enclosure of claim 5, wherein the first roof panel includes a solar panel mounted on the access panel, and wherein the solar panel is configured to charge a battery for the skid assembly.

7. The enclosure of claim 4, wherein the stanchions, right-side door set, left-side door set, front louver panel, rear panel, right side rail, left side rail, and center crosspiece are configured to be packaged as modular components and assembled with removable fasteners.

8. The enclosure of claim 1, wherein the skid assembly includes a welded base having a pair of side rails, each of the side rails including a vertical portion and a horizontal top portion, the top portion having longitudinal slots formed therein, and
wherein the stanchions are mounted to the welded base through the longitudinal slots.

9. The enclosure of claim 1, wherein the rear panel is selected, from a plurality of different rear panels, to accommodate an installed pump on the skid assembly.

10. The enclosure of claim 1, wherein the skid assembly is convertible between a wheeled trailer configuration and a drag skid configuration, and
wherein the enclosure is configured mount to the skid assembly in both the wheeled trailer configuration and the drag skid configuration.

11. The enclosure of claim 1, wherein the front louver panel, when secured to the frame, is configured to seal against a radiator of an engine mounted on the skid assembly.

12. An enclosed skid assembly, comprising:
a welded base including side rails, wherein each of the side rails includes a vertical portion and a horizontal top portion;
multiple crosspieces spanning between the side rails, wherein the multiple crosspieces support an engine and a pump; and
an enclosure, comprising:
a frame configured to be mounted on the welded base using removeable fasteners, wherein the frame includes a front-right vertical stanchion, a front-left vertical stanchion, a rear-right vertical stanchion, and a rear-left vertical stanchion;
a right-side door set including two first door panels mounted to a first side of the frame via first hinges;
a left-side door set including two second door panels mounted to a second side of the frame via second hinges;
a front louver panel mounted to a third side of the frame via third hinges and removeable fasteners; and
a rear panel removably mounted to a fourth side of the frame via removable fasteners,
wherein each of the crosspieces and the stanchions are mounted on the horizontal top portions of the rails,
wherein the right side door set opens side-to-side to fully expose a first horizontal distance between the front-right vertical stanchion and the rear-right vertical stanchion, and
wherein the left side door set opens side-to-side to fully expose a second horizontal distance between the front-left vertical stanchion and the rear-left vertical stanchion.

13. The enclosed skid assembly of claim 12, wherein the frame further includes:
a right side rail joined to the front-right vertical stanchion and the rear-right vertical stanchion by bolted connections,
a left side rail joined to the front-left vertical stanchion and the rear-left vertical stanchion by bolted connections, and
a center crosspiece bolted to the left side rail and the right side rail.

14. The enclosed skid assembly of claim 13, wherein the enclosure further comprising:
a first roof panel configured to be mounted to the right side rail, the left side rail, and the center crosspiece via removable fasteners, and
a second roof panel configured to be mounted to the right side rail, the left side rail, and the center crosspiece via removable fasteners.

15. The enclosed skid assembly of claim 12, wherein each top portion of the side rails includes longitudinal slots formed therein,
wherein the stanchions are mounted to the welded base through some of the longitudinal slots, and
wherein the crosspieces are mounted to the welded base through other of the longitudinal slots.

16. The enclosed skid assembly of claim 12, further comprising:
control panel mount configured to be removably attached to the frame and provide a surface for mounting a control panel within the enclosure.

17. The enclosed skid assembly of claim 12, wherein the rear panel is selected, from a group of multiple different rear panels, to accommodate a suction flange and a discharge flange arrangement of the pump on the skid assembly.

18. The enclosed skid assembly of claim 12, wherein the skid assembly is convertible between a wheeled trailer configuration and a drag skid configuration, and
wherein the enclosure is configured mount to the welded base in both the wheeled trailer configuration and the drag skid configuration.

19. A method of assembling an enclosure for a for a skid assembly, the method comprising:
selecting an enclosure kit sized for the skid assembly, the enclosure kit including multiple vertical stanchions, a right-side door set, a left-side door set, a front louver panel, a rear panel, a right side rail, a left side rail, a center crosspiece, a first roof panel, and a second roof panel;
assembling, via bolted connections, a frame for the enclosure, the frame comprising the multiple vertical stanchions, the right side rail, the left side rail, and the center crosspiece;
resting the frame on a pair of longitudinal side rails of a skid base;
attaching each of the multiple vertical stanchions to the skid base;
attaching the right-side door set to a first side of the frame via first hinges, wherein the right side door set opens side-to-side to fully expose a first horizontal distance between two of the multiple vertical stanchions;
attaching the left-side door set to a second side of the frame via second hinges, wherein the left side door set opens side-to-side to fully expose a second horizontal distance between another two of the multiple vertical stanchions;
attaching the front louver panel to a third side of the frame via third hinges and removeable fasteners;
attaching the rear panel to a fourth side of the frame via removable fasteners;
attaching the first roof panel to the right side rail, the left side rail, and the center crosspiece via removable fasteners; and
attaching the second roof panel to the right side rail, the left side rail, and the center crosspiece via removable fasteners.

20. The method of claim 19, wherein the skid assembly includes an engine and a pump mounted on mounting crosspieces that span the distance between the pair of longitudinal side rails, and
wherein resting the frame on the pair of longitudinal side rails includes placing the mounting crosspieces on horizontal top portions of the rails and placing the multiple vertical stanchions on the horizontal top portions of the rails.
